(19) United States
(12) Patent Application Publication
(10) Pub. No.: US 2024/0390989 A1
(43) Pub. Date: Nov. 28, 2024

(54) TOOL BIT AND BIT HOLDER

(71) Applicant: MILWAUKEE ELECTRIC TOOL CORPORATION, Brookfield, WI (US)

(72) Inventors: Kyle Reeder, Waukesha, WI (US); James Wekwert, Wauwatosa, WI (US); Jeremy R. Ebner, East Troy, WI (US); Troy C. Thorson, Cedarburg, WI (US); Jacob P. Schneider, Cedarburg, WI (US); Douglas W. Allen, Oconomowoc, WI (US); James J. Van Essen, Hales Corners, WI (US); Ian H.A. Blair, Wauwatosa, WI (US); John J. Springer, Milwaukee, WI (US)

(21) Appl. No.: 18/694,805

(22) PCT Filed: Oct. 20, 2022
(86) PCT No.: PCT/US22/47244

§ 371 Date: Mar. 22, 2024

Related U.S. Application Data
(60) Provisional application No. 63/257,687, filed on Oct. 20, 2021.

(51) Int. Cl. B23B 31/117; B25B 15/00; B25B 23/00

(52) U.S. Cl. CPC B23B 31/1173; B25B 23/0035; B25B 15/005

(57) ABSTRACT

A tool bit including a tip configured to engage a work surface, a shank extending from the tip and defining a longitudinal axis, and a drive portion coupled to an end of the shank opposite from the tip and configured to be engaged by a tool, wherein the drive portion includes a plurality of splines circumferentially spaced around the longitudinal axis, each spline having opposing sidewalls which extend through the drive portion

### CROSS-REFERENCE TO RELATED APPLICATION

This application claims priority to U.S. Provisional Application No. 63/257,687, filed on Oct. 20, 2021, and entitled “TOOL BIT AND BIT HOLDER”, the contents of which are hereby incorporated by reference in their entirety.

### FIELD OF THE INVENTION

The present invention relates to tool bits and bit holders, and more particularly to a drive portion of a tool bit.

### SUMMARY

In one aspect, the invention provides a tool bit including a tip configured to engage a work surface, a shank extending from the tip and defining a longitudinal axis, and a drive portion coupled to an end of the shank opposite from the tip and configured to be engaged by a tool, wherein the drive portion includes a plurality of splines circumferentially spaced around the longitudinal axis, each spline having opposing sidewalls which extend through the drive portion.

In another independent aspect, the invention provides a bit holder assembly for securing a bit comprising a power groove to the bit holder assembly, the bit holder assembly including a base member including an opening, a barrel movable relative to the base member, and a shuttle received within the opening and biased by a shuttle spring away from the base member, the shuttle including a cutout. The bit holder assembly further comprises a first retainer located adjacent the bit, and a second retainer located adjacent the shuttle. The bit holder assembly is movable between a released position in which the first retainer is removed from the power grove and the and a locked position in which the first retainer is retained within the power groove and the second retainer is received in the cutout.

In another independent aspect, the invention provides a bit holder for receiving a bit. The bit holder comprises a body, an opening, and a spline feature. The body has aa first end and a second end opposite the first end. The second end is configured to be secured to a drive for movement by the drive. The opening is formed through the first end of the body. The spline feature is positioned within the opening and between the first end and the second end. The spline feature includes a tapered end facing the first end such that as the bit is moved into the opening and towards the second end, the spline feature abuts the bit to guide the bit into axial alignment with the bit holder.

Other aspects of the invention will become apparent by consideration of the detailed description and accompanying drawings.

### BRIEF DESCRIPTION OF THE DRAWINGS

FIG. 1 is a perspective view of a tool bit in accordance with an embodiment of the invention.

FIG. 2 is a top view of a portion of the tool bit of FIG. 1.

FIG. 3 is an end view of the tool bit having four splines.

FIG. 4 is an end view of an alternate tool bit having three splines.

FIG. 5 is a perspective view of a bit holder assembly in accordance to a first embodiment of the invention.

FIG. 6 is an exploded view of the bit holder assembly of FIG. 5.

FIG. 7 is a cross-sectional view of the bit holder assembly of FIG. 5 taken along section line 7-7 of FIG. 5 with a bit secured to an anvil.

FIG. 8 is a cross-sectional view of the bit holder assembly of FIG. 5 taken along section line 8-8 of FIG. 5 with the bit released from the anvil.

FIG. 9 is a perspective view of the bit of FIG. 7.

FIG. 10 is a side view of the bit of FIG. 7.

FIG. 11 is an end view of the bit of FIG. 7.

FIG. 12 is a perspective view of the anvil of FIG. 7.

FIG. 13 is a side view of the anvil of FIG. 7.

FIG. 14 is a perspective view of a spindle configured for use with the bit.

FIG. 15 is a side view of the spindle of FIG. 14

FIG. 16 is a perspective view of a small splined bit.

FIG. 17 is a side view of the small splined bit of FIG. 16.

FIG. 18 is a first end view of the small splined bit of FIG. 16.

FIG. 19 is a second end view of the small splined bit of FIG. 16.

FIG. 20 is a perspective view of an anvil configured for use with the small splined bit of FIG. 16.

FIG. 21 is a side view of the anvil of FIG. 20.

FIG. 22 is a cross-sectional view of the anvil of FIG. 20 taken along section line 22-22 in FIG. 20.

FIG. 23 is a perspective view of a spindle configured for use with the small splined bit of FIG. 16.

FIG. 24 is a side view of the spindle of FIG. 23.

FIG. 25 is a cross-sectional view of the spindle of FIG. 23 taken along section line 25-25 of FIG. 23.

FIG. 26 is a perspective view of a large splined bit.

FIG. 27 is a side view of the large splined bit of FIG. 26.

FIG. 28 is a first end view of the large splined bit of FIG. 26.

FIG. 29 is a second end view of the large splined bit of FIG. 26.

FIG. 30 is a perspective view of an anvil configured for use with the large splined bit of FIG. 26.

FIG. 31 is a side view of the anvil of FIG. 30.

FIG. 32 is a cross-sectional view of the anvil taken along section line 32-32 in FIG. 30.

FIG. 33 is a perspective view of a spindle configured for use with the large splined bit of FIG. 26.

FIG. 34 is a side view of the spindle of FIG. 33

FIG. 35 is a cross-sectional view of the spindle of FIG. 33 taken along section line 23-23 in FIG. 35.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

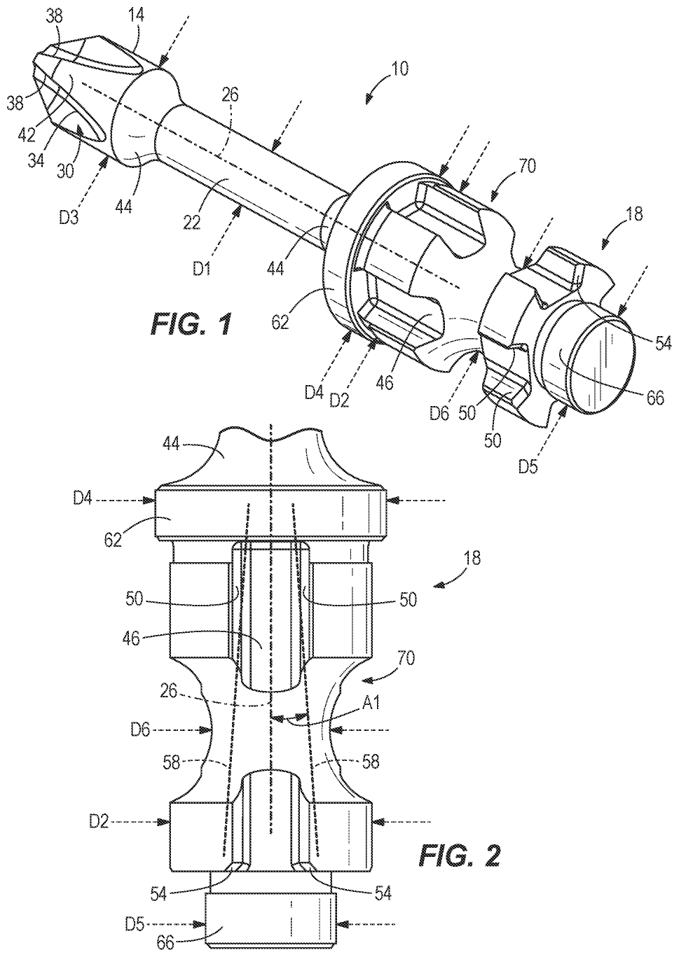

FIGS. 1-2 illustrate a tool bit 10 including a tip 14, a drive portion 18, and a shank 22 interconnecting the tip 14 and the drive portion 18. The tool bit 10 also includes a central longitudinal axis 26 (i.e., axis 26) extending through the tip 14, the shank 22, and the drive portion 18. The central longitudinal axis 26 defines a rotational axis of the tool bit 10. In the illustrated embodiment, the tool bit 10 is a driver bit. In other embodiments, the tool bit may be other suitable types of bits. For example, the tool bit may be a drill bit, such as a twist drill bit, a step drill bit, an auger bit, a spade bit, and the like. The tool bit 10 may also be another type of bit having a drive portion 18. Alternatively, the tool bit 10 may be part of a tool having a drive portion 18 (e.g., a socket adapter, a hole saw arbor, a driver sleeve, etc.).

With reference to FIG. 1, the tip 14 is coupled to an end of the shank 22 opposite from the drive portion 18. In the illustrated embodiment, the tip 14 is integrally formed with the shank 22. Alternatively, the tip 14 may be a separate piece that is permanently secured to the shank 22. The tip 14 provides a working end or head for the bit 10 and is configured to engage a fastener (e.g., a screw). In the illustrated embodiment, the tip 14 is configured as a Philips-style tip. Alternatively, the tip 14 may have other configurations to engage different styles of fasteners. For example, the tip 14 may be configured as a straight blade (otherwise known as a “regular head”) to engage fasteners having a corresponding straight slot. Other tip configurations (e.g., hexagonal, star, square, etc.) may also be employed with the bit 10.

The tip 14 includes a plurality of flutes 30, or recesses, circumferentially spaced around the tip 14 to form the Philips-style tip. The illustrated flues 30 are equidistantly disposed about the axis 26. The flutes 30 extend longitudinally along the tip 14 and converge into vanes 34. The vanes are formed with flat, tapered (variable radial distance from axis 26 along the axial length of the axis 26) side walls 38 and outer walls 42. The outer walls 42 are inclined in a direction extending from the tip 14 towards the drive portion 18. The vanes 34 are also equidistantly disposed around the tip 14. In the illustrated embodiment, the vanes 34 gradually increase in thickness in a direction extending from the tip 14 towards the drive portion 18. The illustrated flutes 30 are defined by a single, curved surface having a radius of curvature. The radius of curvature is continuous between adjacent vanes 34.

The shank 22 extends between the tip 14 and the drive portion 18. In the illustrated embodiment, the shank 22 is integrally formed with the drive portion 18, but may alternatively be a separate piece that is permanently secured to the drive portion 18. The illustrated shank 22 has a reduced diameter, or dimension D1 perpendicular to the axis 26 compared to the remainder of the bit 10. More particularly, the reduced diameter D1 is an outer diameter of the shank 22, which is smaller than an outer diameter, or dimension, D2 of the drive portion 18 and a maximum outer diameter, or dimension D3, of the tip 14. The shank 22 further includes a fillet 44 at either end, transitioning to the larger diameter tip 14 and drive portion 18. The fillets 44 are contiguous with the tip 14 and the drive portion 18. In addition, each fillet 44 has a generally constant radius of curvature between the shank 22 and the tip 14 or the drive portion 18. In other embodiments, the shank 22 may have generally the same diameter as the drive portion 18 and/or the tip 14. The shank 22 may also be of various lengths along the axis 26.

The drive portion 18 is configured to be engaged by any number of different tools, adapters, or components to receive torque from the tool, adapter, or component to rotate the tool bit 10. For example, the tool bit 10 may be used with a drill driver, impact driver, or hammer drill having a chuck that receives the drive portion 18. Alternatively, the tool bit 10 may be used with a hand tool having a socket or other suitable structure that receives the drive portion 18. The tool may include a quick release structure (e.g., a ball detent) that engages a circumferential power groove in a conventional hex-shaped drive portion.

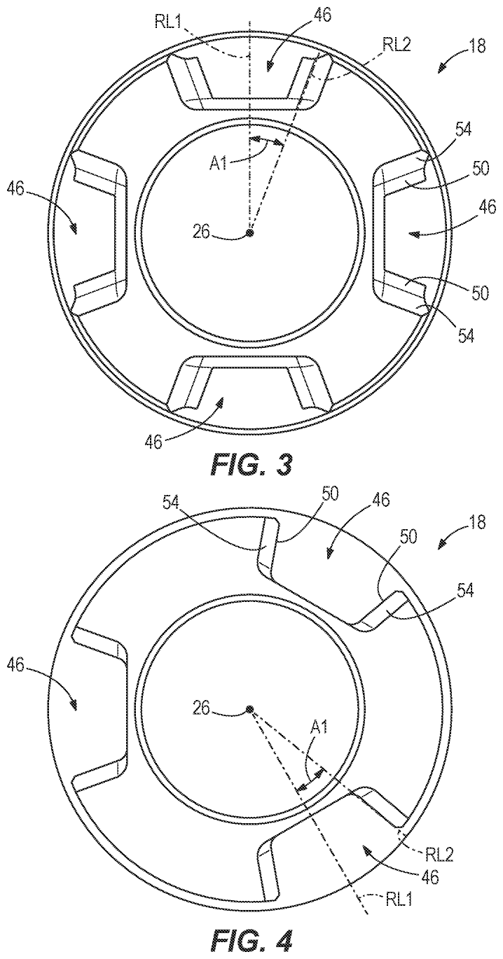

As shown in FIGS. 1-2, the drive portion 18 of the tool bit 10 has a generally cylindrical cross-section and a plurality of splines 46. The illustrated tool bit 10 has splines 46 which are evenly circumferentially spaced about the axis 26. The illustrated tool bit 10 has four splines 46 (FIG. 3) which are evenly circumferentially spaced about the axis 26. Other embodiments of the tool bit 10 may include other numbers of splines 46 (e.g., three splines 46, FIG. 4), or may include splines 46 which are unevenly circumferentially spaced about the axis 26. The splines 46 extend generally parallel with the axis 26, and are depressions (i.e., recesses) in the drive portion 18. The splines 46 each extend through the drive portion 18. The splines 46 each are defined by opposing sidewalls 50. The opposing sidewalls 50 may be provided with a chamfered edge 54. The edge 54 is provided along an end of each sidewall 50 at a distal portion of the drive portion 18 located opposite the tip 10. The edge 54 may promote quick insertion and release of the tool bit 10 from a tool by providing a surface to push the splines 46 into corresponding features of the tool.

As illustrated in FIG. 2, the illustrated sidewalls 50 extend generally parallel with the axis 26. However, as shown in FIGS. 3 and 4, the sidewalls 50 may be tapered at an angle A1 with respect to a reference line RL1 extending through the axis 26 and the spline 46. The reference line RL1 extends in a direction perpendicular to the axis 26. The angle A1 is located between the reference line RL1 and a second reference line RL2 passing along the sidewalls 50 and towards the axis 26. In the illustrated embodiment, the reference line RL2 extends through the axis 26. Opposing sidewalls 50 form a single spline 46. In FIG. 2, the sidewalls 50 are generally parallel with each other, and the splines 46 are recessed into the body of the drive portion 18 towards the axis 26. In other words, the illustrated splines 46 are generally rectangularly shaped. However, FIG. 2 also illustrates tapered references lines 58 along which the sidewalls 50 may extend to form tapered splines 46. The tapered references lines 58 are each directed at an angle A2 with respect to the axis 26. As such, tapered splines 46 with sidewalls following the tapered references lines 58 are shaped similar to a trapezoid. In the illustrated embodiment, the tapered references lines 58 converge in a direction extending from the drive portion 18 towards the tip 14. Tapering of the sidewalls 50 along the reference lines 58 may promote quick insertion and release of the tool bit 10 by providing an enlarged surface (i.e., the sidewalls 50 themselves) to push the splines 46 into corresponding features of the tool. In embodiments with splines 46 having sidewalls 50 extending along the tapered reference lines 58 may further include sidewalls 50 with chamfered edges 54.

In the illustrated embodiment, the drive portion 18 also includes a shaft end alignment feature 62 and a drive end alignment feature 66. In the illustrated embodiment, the shaft end alignment feature 62 is integrally formed with the shank 22, but may alternatively be a separate piece that is permanently secured to the drive portion 18. The shaft end alignment feature 62 is generally cylindrical in shape and extends along the axis 26. The shaft end alignment feature 62 is connected to the shaft 22 by the fillet 44. In the illustrated embodiment, the shaft end alignment feature 62 has an enlarged diameter, or dimension D4 compared to the remainder of the bit 10 and thus the remainder of the drive portion 18 (as measured perpendicular to the axis 26). In the illustrated embodiment, the drive end alignment feature 66 is integrally formed with the shank 22, but may alternatively be a separate piece that is permanently secured to the drive portion 18. The drive end alignment feature 66 has a diameter, or dimension D5 which is smaller than the outer diameter D2 of the drive portion 18. Accordingly, the drive end alignment feature 66 may align the tool bit 10 upon first insertion of the tool bit 10 into the tool and prior to the splines 46 contacting corresponding features of the tool.

The drive portion 18 further includes a power groove 70. The power groove 70 is a recess provided on an exterior surface of the drive portion 18. The power groove 70 may be configured (i.e., dimensioned) to receive a ball detent (i.e., retainer) of the tool or a bit holder assembly to secure the axial position of the tool bit 10 within the tool. The power groove 70 may be defined by a single, curved surface having a radius of curvature. The power groove 70 may be revolved around the entirety of the axis 26. The power groove 70 is positioned between axial ends of the drive portion 18. In other words, the power groove 70 may be provided axially between the shaft end alignment feature 62 and the drive end alignment feature 66. The power groove 70 has a diameter, or dimension D6 (extending perpendicular to the axis 26) which is smaller than the outer diameter D2 of the drive portion 18. Accordingly, the ball detent of the tool may be received within the power groove 70 to assist with inhibiting axial runout along the axis 26 in positioning the tool bit 10 within the tool.

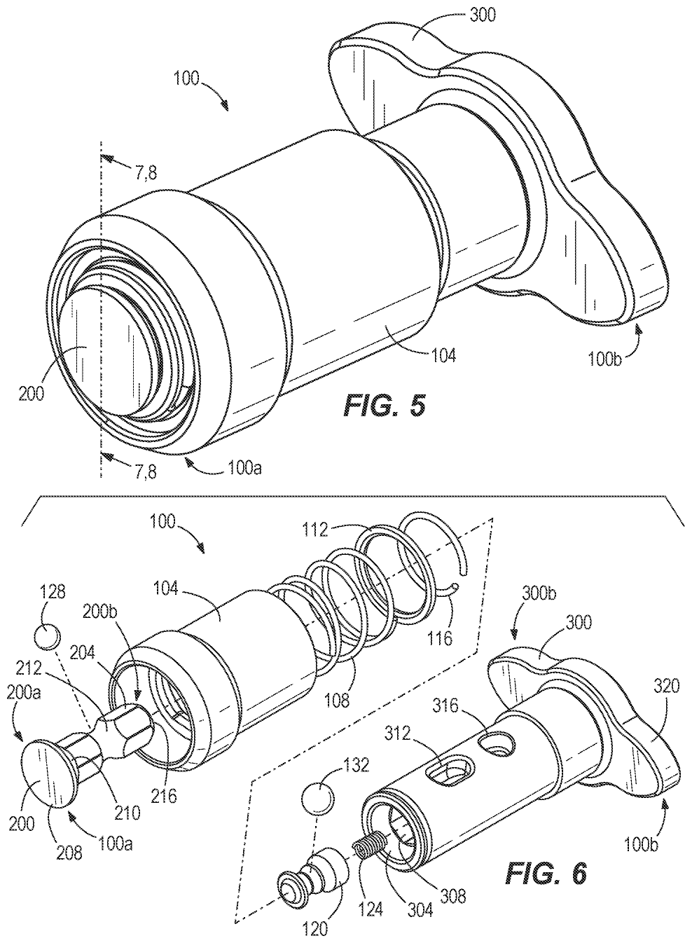

FIGS. 5-8 illustrate a bit holder assembly 100. The bit holder assembly 100 may be configured to retain the tool bit 10 for rotation therewith. The bit holder assembly 100 may also be configured to receive a tool bit 200 for rotation therewith. As illustrated in FIG. 6, the bit holder assembly 100 includes a barrel 104 and a spring 108 which biases the barrel 104 against a base member 300. The base member 300 may be, as illustrated, an anvil 300. The spring 108 includes a portion 116 which is seated against an annular ring 112. The annular ring 112 presses against one end of the spring 108 to bias the barrel 104. The bit holder assembly 100 further includes a shuttle 120 which is biased by a shuttle spring 124 away from the base member 300. As will be described in detail below, the bit holder assembly 100 further includes a bit retainer 128 (e.g., a first ball detent, first retainer) configured to secure the bit 200 to the anvil 300. Finally, the bit holder assembly 100 includes a barrel retainer 132 (e.g., a second ball detent, second retainer) configured to maintain connection between the barrel 104 and the anvil 300.

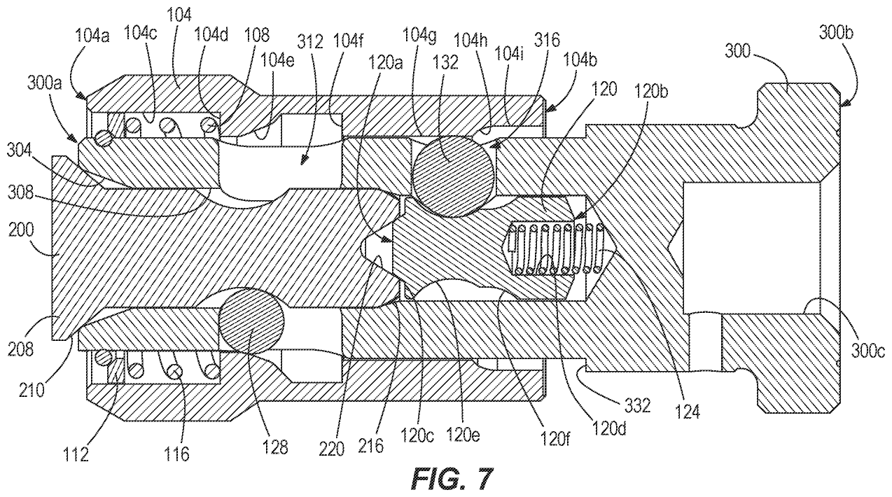

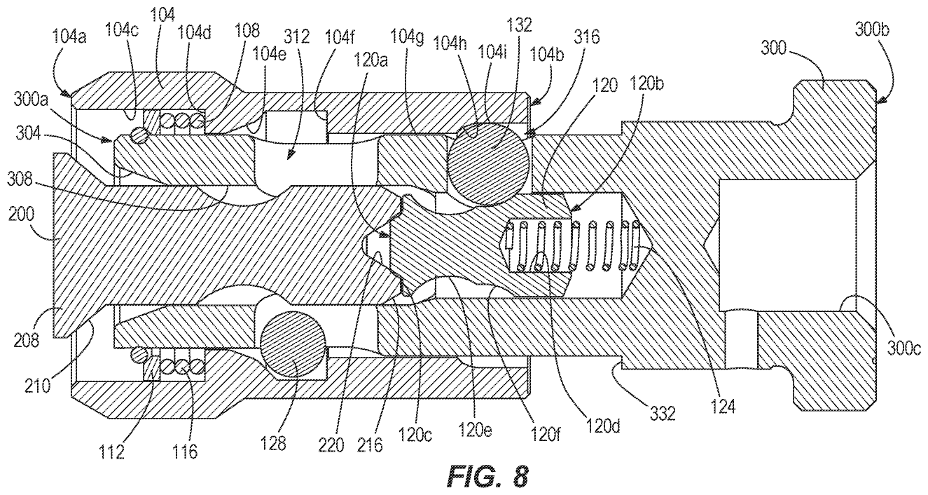

As best illustrated in FIG. 7, the barrel 104 is generally annular in shape between a first end 104a and a second end 104b thereof. Adjacent the first end 104a, and extending towards the second end 104b, the barrel 104 includes an annular surface 104c. The annular surface 104c terminates at a radially inwardly extending surface 104d. The spring 108 is retained between the annular ring 112 and the radially inwardly extending surface 104d. The barrel 104 further includes a transition region 104e which is angled relative to the annular surface 104c. As illustrated in FIGS. 7 and 8, the transition region 104e is configured to pass the bit retainer 128 between radial positions. The barrel 104 further includes another radially inwardly extending surface 104f. As illustrated in FIG. 8, the radially inwardly extending surface 104f functions as an axial stop for the bit retainer 128. The barrel 104 further includes another annular surface 104g. The annular surface 104g is configured to slide along the anvil 300. The barrel 104 further includes another transition region 104h between the annular surface 104g and the second end 104b. The transition region 104h is configured to pass the barrel retainer 132 between radial positions. The transition region 104h is located axially between the annular surface 104g and another annular surface 104i. The annular surface 104i is configured to abut the barrel retainer 132 (FIG. 8). The annular surface 104i is positioned adjacent the second end 104b.

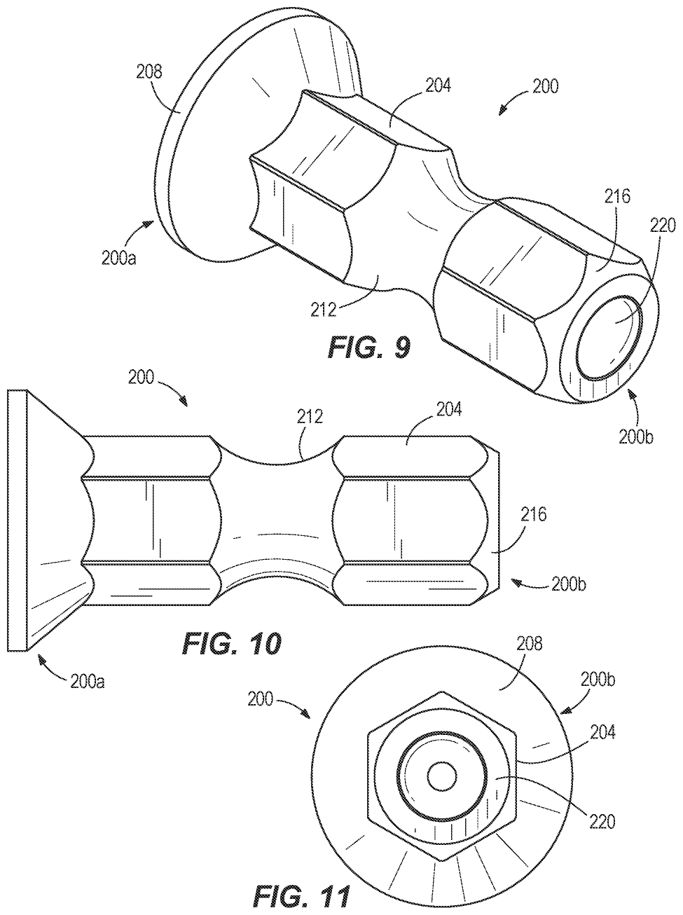

A portion of the bit 200 is illustrated in detail in FIGS. 9-11. The bit 200 includes a shank 204 and a head 208 which includes a larger diameter than the shank 204. In the illustrated embodiment, the shank 204 has a dimension corresponding to a diameter of the shank 204 of 0.635 centimeters (0.25 inches), and the head 208 includes a diameter of approximately 1.12 centimeters (0.44 inches). The head 208 is located at a first end 200a of the bit 200, and the shank 204 is located at a second end 200b of the bit 200. The head 208 is configured to be connected to the remainder of the bit 200, such as a shank and a tip (like the tool bit 10 shown in FIG. 1). In the illustrated embodiment, the shank 204 has a hexagonal cross-section shaped shank 204. The bit 200 includes a power groove 212 similar to the power groove 70 of the bit 10. The second end 200b of the bit 200 is provided with a chamfer 216. Further, the second end 200b of the bit 200 is provided with a depression 220 (see also FIGS. 7-8). In the illustrated embodiment, as shown in FIG. 7, the depression 220 is frustoconical. In other embodiments, the depression 220 may have other shapes.

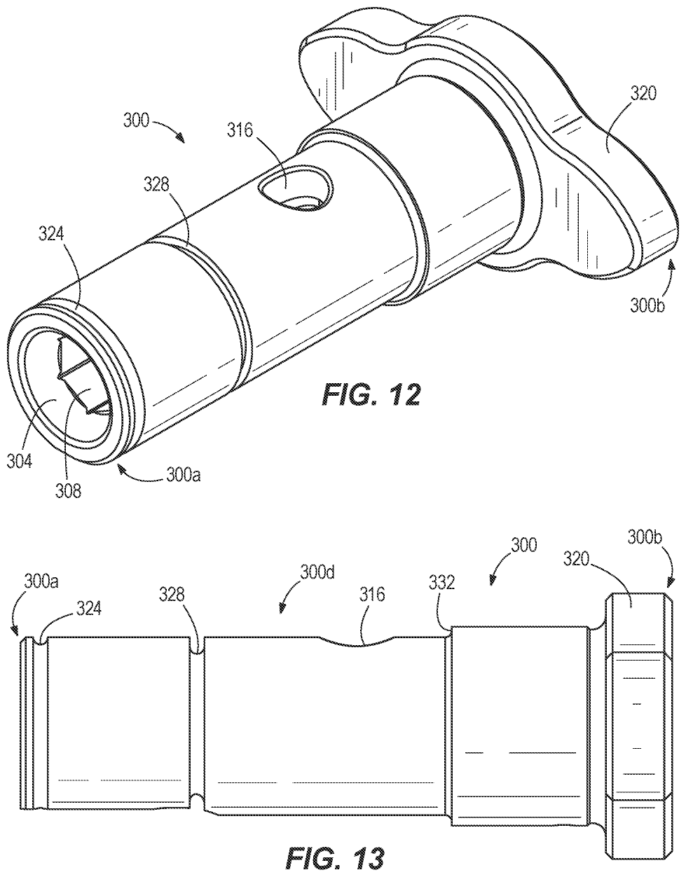

The anvil 300 is illustrated in detail in FIGS. 12-13. The anvil 300 (i.e., bit holder) extends from a first end 300a to a second end 300b. The first end 300a is provided with a tapered annular opening 304. Within the opening 304, a drive surface 308 is provided. The drive surface 308 is dimensioned to engage the tool bit 200. In the illustrated embodiment, the tool bit 200 is a generally hexagonal tool bit 200, and the drive surface 308 is generally hexagonal to receive the tool bit 200. Returning to FIGS. 6-8, the anvil 300 includes a slot 312 and a hole 316. The slot 312 is dimensioned to receive the bit retainer 128 therein. The hole 316 is dimensioned to receive the barrel retainer 132 therein. In the illustrated embodiment, the barrel retainer 132 is a spherical ball detent. As illustrated in FIGS. 12-13, the second end 300b of the anvil 300 includes a shoulder surface 320 which projects radially outwardly from the annular opening 304. In the illustrated embodiment, the shoulder surface 320 may be secured to a drive (not shown) for rotation. The anvil 300 is rotated by the drive, and the bit assembly 100 is secured to the anvil 300 for co-rotation therewith. A channel 324 is formed adjacent the first end 300a of the annular opening 304. The channel 324 is a generally annular depression in the opening 304 for receiving the annular ring 112. In the anvil 300 illustrated in FIGS. 12-13, another channel 328 is provided between the channel 324 and the hole 316. In some other embodiments, such as the anvil 300 illustrated in FIG. 6, no such channel 328 is present.

Referring to FIGS. 7 and 8, the shuttle 120 includes a first end 120a and an opposite second end 120b. The first end 120a of the shuttle 120 includes an angled surface 120c. The angled surface 120c generally corresponds with the angle of the frustoconical depression 220 of the tool bit 200. The second end 120b of the shuttle 120 includes a hole 120d. The hole 120d at least partially receives the shuttle spring 124 therein. Between the first end 120a and the second end 120b, the shuttle 120 is provided with two cutouts 120e (i.e., a “first” cutout), 120f (i.e., a “second” cutout). The cutouts 120e, 120f are radially inwardly extending depressions on the exterior surface of the shuttle 120. In some embodiments, the cutouts 120e, 120f contact each other. The first cutout 120e is positioned closer than the second cutout 120f to the first end 120a. The second cutout 120f is positioned closer than the first cutout 120e to the second end 120b. As illustrated in FIG. 7, the first cutout 120e is dimensioned to secure the barrel retainer 132 in a radially inward position against the annular surface 104g. As illustrated in FIG. 8, the second cutout 120f is dimensioned to secure the barrel retainer 132 in a radially outward position against the annular surface 104i.

The bit holder assembly 100 is movable between a locked position (FIG. 7) in which the bit 200 is secured to the anvil 300 and a released position (FIG. 8) in which the bit 200 is movable relative to the anvil 300. Prior to the bit 200 being locked, the bit 200 may be moved from external of the anvil 300 to the released position of FIG. 8. The bit 200 may be translated into the anvil 300. During such translation, the second end 200b is inserted into the tapered opening 304. In some cases, the tool bit 200 may be axially misaligned with respect to the anvil 300, and the chamfer 216 may abut the tapered opening 304. The chamfer 216 and tapered opening 304 may guide the tool bit 200 into axial alignment with the anvil 300. In the released position of FIG. 8, the tool bit 200 abuts the shuttle 120 with the depression 220 engaged with the angled surface 120c with the spring 124 in a relaxed state. In the released position (FIG. 8), the spring 108 is in a compressed state with the barrel 104 biasing the spring 108. The barrel retainer 132 abuts the annular surface 104i with the barrel retainer 132 in a radially outward position. The barrel retainer 132 is also received in the second cutout 120f in the released position (FIG. 8). In the released position (FIG. 8), the bit retainer 128 abuts the shank 104, and is displaced from the power groove 212. The bit retainer 128 also abuts the radially inwardly extending surface 104d. In some embodiments, the bit retainer 128 is biased radially inwardly. In some embodiments, an o-ring may be positioned radially inwardly of the transition region 104e and/or radially inwardly of the inwardly extending surface 104f to bias the bit retainer 128 radially inwardly. Other structures and/or locations of such a biasing element may also be employed.

The bit holder assembly 100 may be moved from the released position (FIG. 8) to the locked position (FIG. 7). In this transition, the barrel 104 is moved axially towards the second end 300b of the anvil 300. Axial movement of the barrel 104 causes radial movement of the barrel retainer 132. In the transition to the locked position (FIG. 7), the barrel retainer 132 is passed along the transition region 104h to a radially inner position in which the barrel retainer 132 is received in the first cutout 120e. The barrel retainer 32 abuts the annular surface 104g in the locked position (FIG. 7). In the locked position (FIG. 7), the shuttle 120 is translated into the anvil 300 with the shuttle spring 124 being compressed. The head 208 of the tool bit 200 abuts the tapered opening 304. The bit retainer 128 is passed along the transition region 104e such that the bit retainer 128 is received within the power groove 212 of the bit 200. In the locked position (FIG. 7), the spring 108 biases the barrel 104 axially to prevent the barrel retainer 132 from moving radially outwardly. The barrel 104 is thus locked, and the bit retainer 128 secures the axial position of the tool bit 200 relative to the anvil 300. In the locked position, the contoured face 104e will act as a wedge to press upon the bit 200 and force axial translation of the bit. This axial translation is stopped by the contact of the transition region 210 of the bit 200 upon the first end 300a of the anvil 300.

As illustrated in FIG. 7, the depression 220 may be seated against the angled surface 120c of the shuttle 120 when the bit holder assembly 100 is in the locked position. This serves to axially and radially seat the tool bit 200 against the shuttle 120. As illustrated in FIG. 7. The tool bit 200 includes a transition region 210 which is angled in a radial direction to transition the tool bit 200 between the head 208 and the shank 204. The transition region 210 may contact the first end 300a of the anvil in the locked position. More specifically, the transition region 210 may contact an edge between the tapered annular opening 304 and the first end 300a. This serves to axially and radially seat the tool bit 200 against the anvil 300. In some other embodiments, the annular opening 304 may not be tapered, and the transition region 210 may include a 90 degree angle to form a surface of engagement between the tool bit 200 and the first end 300a. Due to the seating of the depression 220 in the angled surface 120c and the seating of the transition region 210 upon the first end 300a, undesired runout of the tool bit 200 relative to the anvil 300 may be mitigated.

In some existing embodiments, tool bits (not shown) with hexagonal shafts may be expected to be deflected a runout dimension of around 0.40 millimeters. In some existing embodiments, tool bits (not shown) with chuck features may be expected to be deflected a runout dimension of around 0.20 millimeters. As a result of the seating of the depression 220 in the angled surface 120c and the seating of the transition region 210 upon the first end 300a, the bit holder assembly 100 be expected to deflect a runout dimension of around 0.14 millimeters. The runout dimension may be axially (i.e., along an axis extending between the first end 200a and the second end 200b) or radially (i.e., in a direction extending away from the axis extending between the first end 200a and the second end 200b).

Reverse operation of the bit holder assembly 100 from the locked position (FIG. 7) to the release position (FIG. 8) is also possible. To move the bit holder assembly 100 from the locked position (FIG. 7) to the release position (FIG. 8), a user translates the barrel 104 against biasing force of the spring 108. The barrel retainer 132 is then allowed to move radially outwardly and into the second cutout 120f, and the bit retainer 128 is then allowed to move radially outwardly of the power groove 212 and onto the exterior of the shank 204.

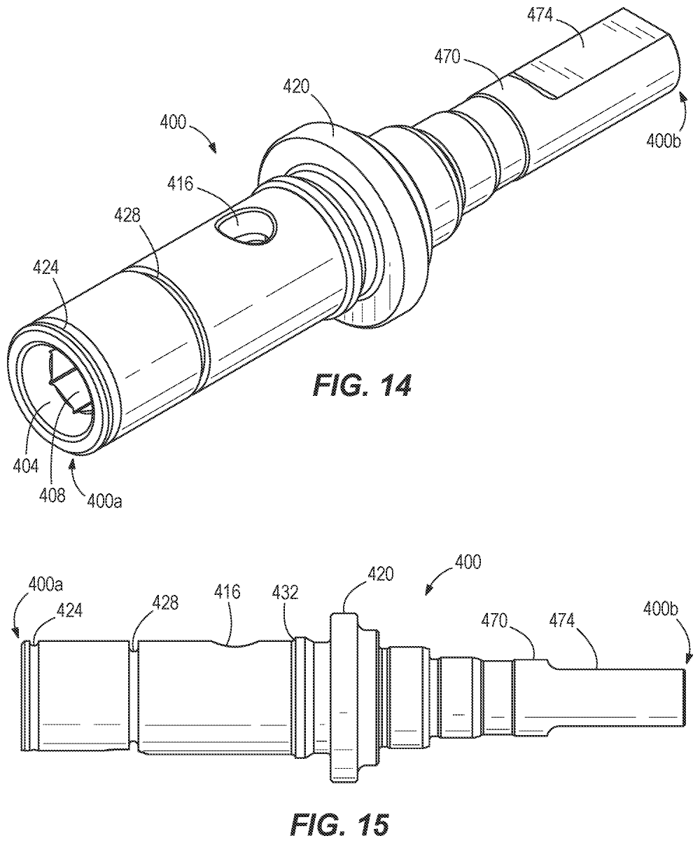

FIGS. 14-15 illustrate a spindle 400 (i.e., bit holder) with similar features to the anvil 300. Like features between the anvil 300 and the spindle 400 are annotated with like reference numerals in the “400” series of reference numbers. The spindle 400 is operable to receive the bit 200 therein, and may be used with the bit holder assembly 100 in a similar fashion. As illustrated in FIGS. 14-15, the spindle 400 includes a shoulder surface 420 at an intermediate position between the first end 400a and the second end 400b thereof. A shaft 470 projects from the shoulder surface 420 to the second end 400b. The shaft 470 includes drive portions 474 configured to be rotated by a drive (not shown). In the illustrated embodiment, the shaft 470 is generally cylindrical, and the drive portions 474 are planar cutouts in the shaft 470.

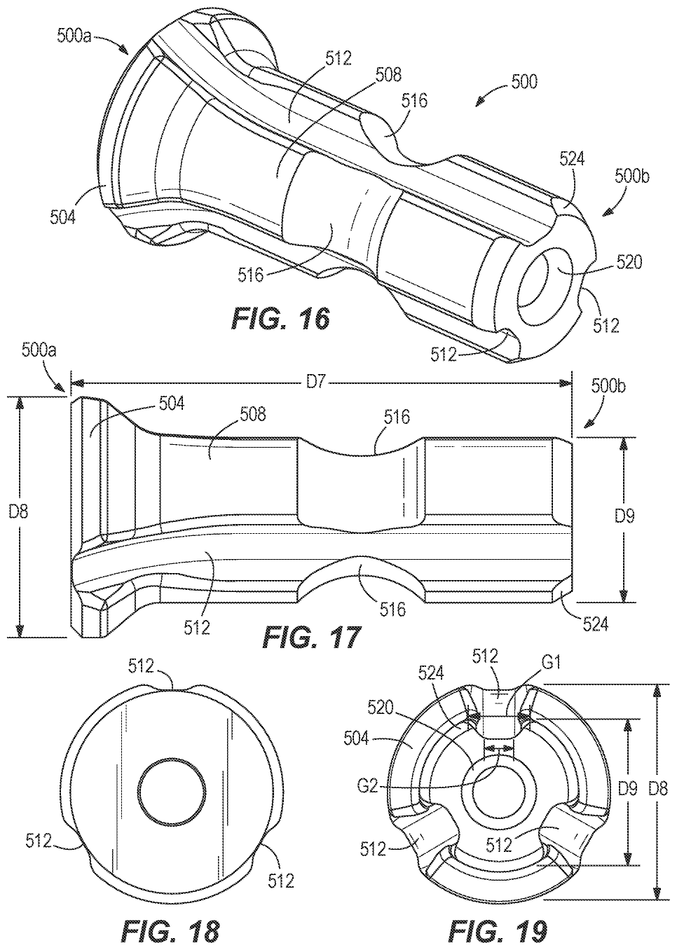

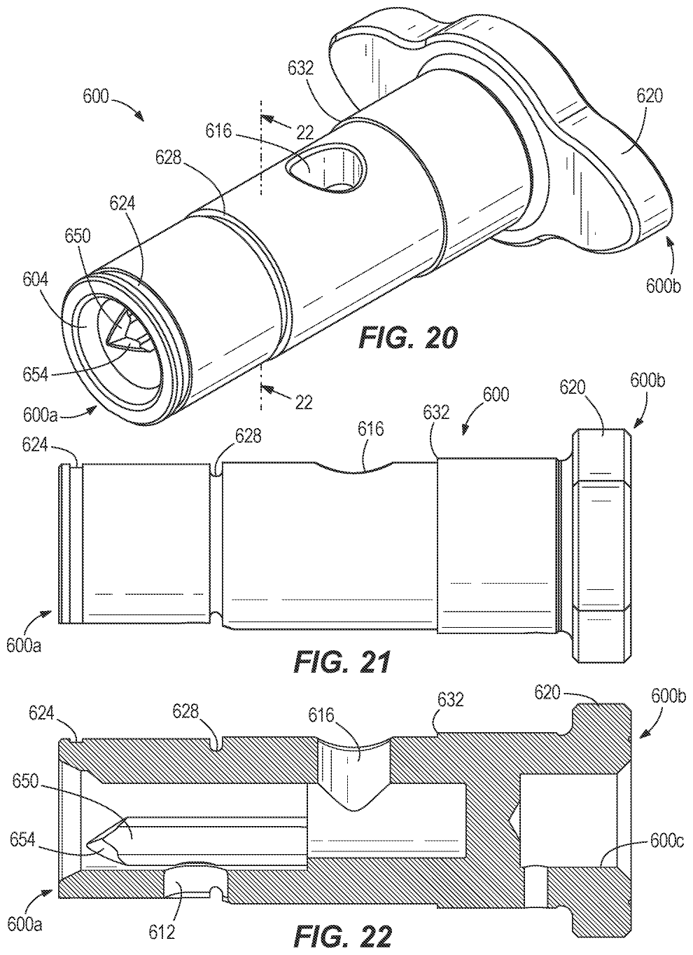

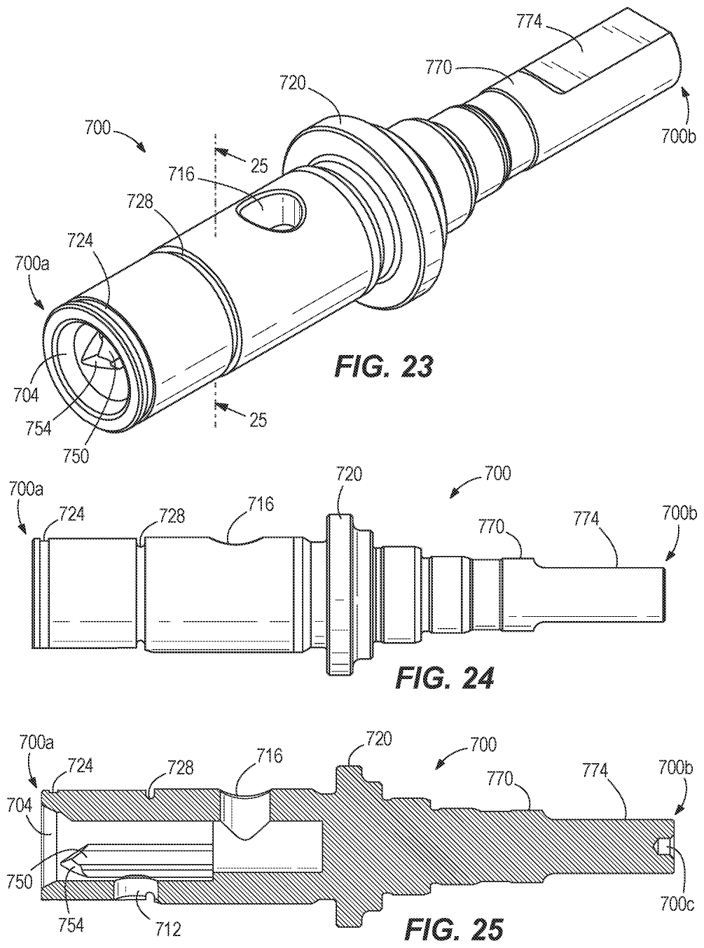

FIGS. 16-19 illustrate another portion of a tool bit 500. The tool bit 500 may by considered a small splined bit 500. The small splined bit 500 is configured to be received by an anvil 600 (FIGS. 20-22, discussed below) or a spindle 700 (FIGS. 23-25, discussed below). The anvil 600 and spindle 700 may also be configured to engage the tool bit 10 (FIGS. 1-4). The tool bit 500 (FIGS. 16-19) includes a head 504 and a shank 508. Splines 512 extend axially along both the head 504 and the shank 508. As illustrated in FIGS. 16 and 19, the splines 512 extend radially inwardly towards the center of the tool bit 500. However, in other embodiments, the splines 512 may be replaced with a positive feature (not shown) which extends radially outwardly away from the center of the tool bit 500. Such a positive feature (e.g., the splines 512 provided in a manner reverse to the illustrated splines 512 of FIG. 16) may be, in some embodiments, either welded or pressed into the shank 508 in a manner similar to a woodruff key. Such a connection may enhance manufacturability of the tool bit 500 and/or may enhance serviceability of the tool bit 500 and/or the anvil 600 as the splines 512 become worn. The splines 512 may include sidewalls which are tapered. In the illustrated embodiment, the sidewalls of the splines 512 are tapered at approximately 60 degrees (FIG. 19). Other taper angles may be suitable. The splines 512 include a maximum gap G1 (i.e., a spline width) between sidewalls thereof of approximately 0.3175 centimeters (0.125 inches) (FIG. 19). In other embodiments, the gap G1 (i.e., the spline width) may be between 0.2 centimeters (about 0.79 inches) and 0.5 centimeters (about 0.2 inches). In other embodiments, the gap G1 (i.e., the spline width) may be between 0.3 centimeters (about 0.12 inches) and 0.4 centimeters (about 0.16 inches). However, the gap G1 may be larger or smaller depending desired characteristics. As such, the spline 512 is generally considered an eighth inch spline. The maximum gap G1 is measured between the sidewall of the spline 512 at a radially outer surface of the spline 512. The splines 512 include a minimum gap G2 between sidewalls thereof of approximately 0.03 inches (FIG. 19). The minimum gap G2 is measured between the sidewalls of the spline 512 at a radially inner surface of the spline 512. The tool bit 500 further includes a power groove 516 similar to the power grooves 70, 212, and a chamfer 524 similar to the chamfer 216. Finally, the tool bit 500 includes a frustoconical depression 520 (FIGS. 16, 19) similar to the frustoconical depression 220.

As illustrated in FIG. 17, the small splined bit 500 extends along an axial length dimension D7 between a first end 500a and a second end 500b thereof. The head 504 is adjacent the first end 500a thereof, and includes a diameter, or dimension D8. The shank 508 is adjacent the second end 500b thereof, and includes a diameter, or dimension D9 which is smaller than the diameter D8. In the illustrated embodiment, the dimension D7 is about 0.89 inches. In the illustrated embodiment, the dimension D8 is about 0.44 inches. In the illustrated embodiment, the dimension D9 is about 0.31 inches. As such, dimension D9 is approximately 70% of dimension D8 and approximately 35% of dimension D7 in the illustrated embodiment. Similarly, dimension D8 is approximately 49% of dimension D7 in the illustrated embodiment. In other embodiments, dimension D9 may be between 60% and 80% of dimension D8, and may be between 25% and 45% of dimension D7. In other embodiments, dimension D8 may be between 39% and 59% of dimension D7.

FIGS. 20-22 illustrate the anvil 600 configured for use with the tool bit 500. The anvil 600 is a base member 600 configured for use with the bit assembly 100. Like features between the anvil 300 and the anvil 600 are annotated with like reference numerals in the “600” series of reference numbers. The anvil 600 includes spline features 650 adjacent the opening 604 thereof. The anvil 600 may include a plurality of spline features 650. For example, the anvil 600 may include three spine features 650. The spline features 650 may be evenly circumferentially spaced around the opening 604. In other embodiments, the spline features 650 may be otherwise spaced around the opening 604. The spline features 650 are configured to transfer torque from the anvil 600 to the tool bit 500. The spline features 650 are provided adjacent the first end 600a of the anvil 600. The spline features 650 are provided with a tapered end 654 adjacent the first end 600a. In the illustrated embodiment, the spline features 650 extend radially inwardly from a radial outer portion of the anvil 600 towards the center of the anvil. In some embodiments, the spline features 650 may be receptacles (not shown) which extend radially outwardly from a radial inner portion of the anvil 600 towards a radial outer portion of the anvil 600 (e.g., to receive corresponding positive feature of the small splined bit 500). In other words, the positive and negative features which secure the small splined bit 500 to the anvil 600 may be reversed. Other similar constructions may be possible. During translation of the tool bit 500 into the anvil 600, and while the tool bit 500 is axially misaligned with the opening 604, the tapered end 654 may abut the chamfer 524 to guide the tool bit 500 into axial alignment with the anvil 600. The bit assembly 100 may be used to secure the tool bit 500 to the anvil 600.

FIGS. 23-25 illustrate the spindle 700 configured for use with the tool bit 500. The spindle is a base member 700 configured for use with the bit assembly 100. Like features between the spindle 700 and the spindle 400 are annotated with like reference numerals in the “700” series of reference numbers. The spindle 700 includes spindle features 750 adjacent the opening 704 thereof. The spline features 750 are configured to transfer torque from the spindle 700 to the tool bit 500. The spline features 750 are provided adjacent the first end 700a of the spindle 700. The spline features 750 are provided with a tapered end 754 adjacent the first end 700a. During translation of the tool bit 500 into the spindle 700, and while the tool bit 500 is axially misaligned with the opening 704, the tapered end 754 may abut the chamfer 524 to guide the tool bit 500 into axial alignment with the spindle 700. The bit assembly 100 may be used to secure the tool bit 500 to the spindle 700. As with the spline features 650, the spindle features 750 may be either a positive feature (as illustrated in FIG. 25) extending radially inwardly towards the center of the spindle 700 from a radially outer portion of the spindle 700 or a negative feature (not shown) extending radially outwardly away from the center of the spindle 700.

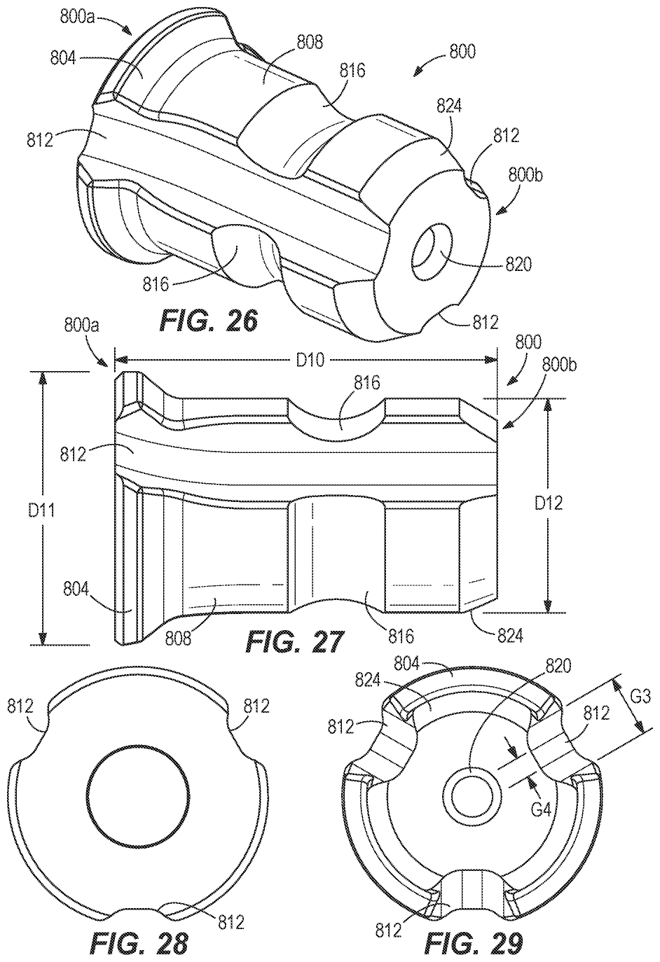

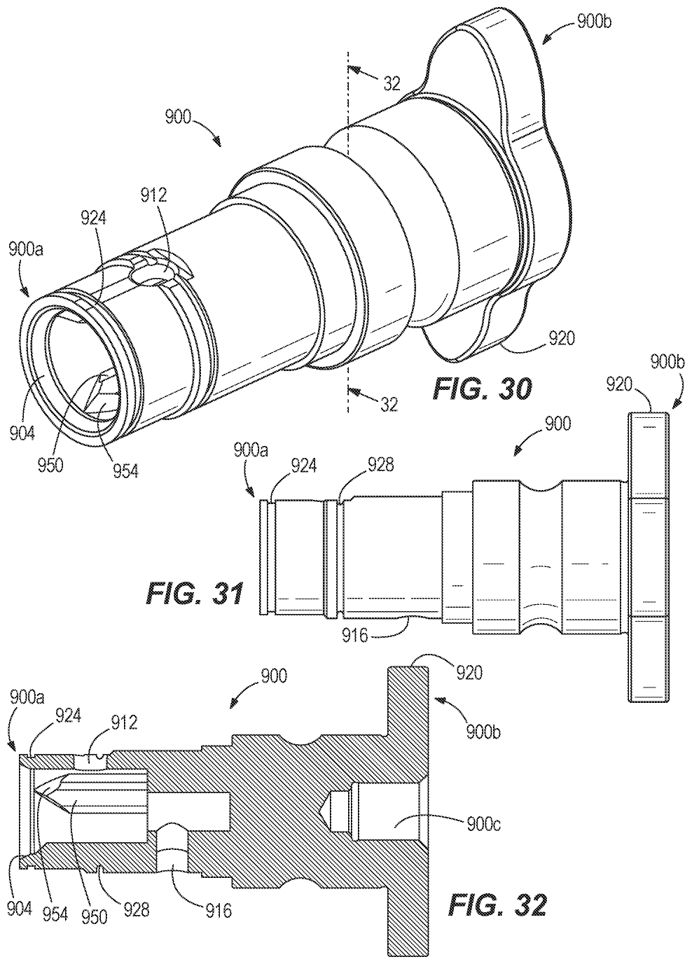

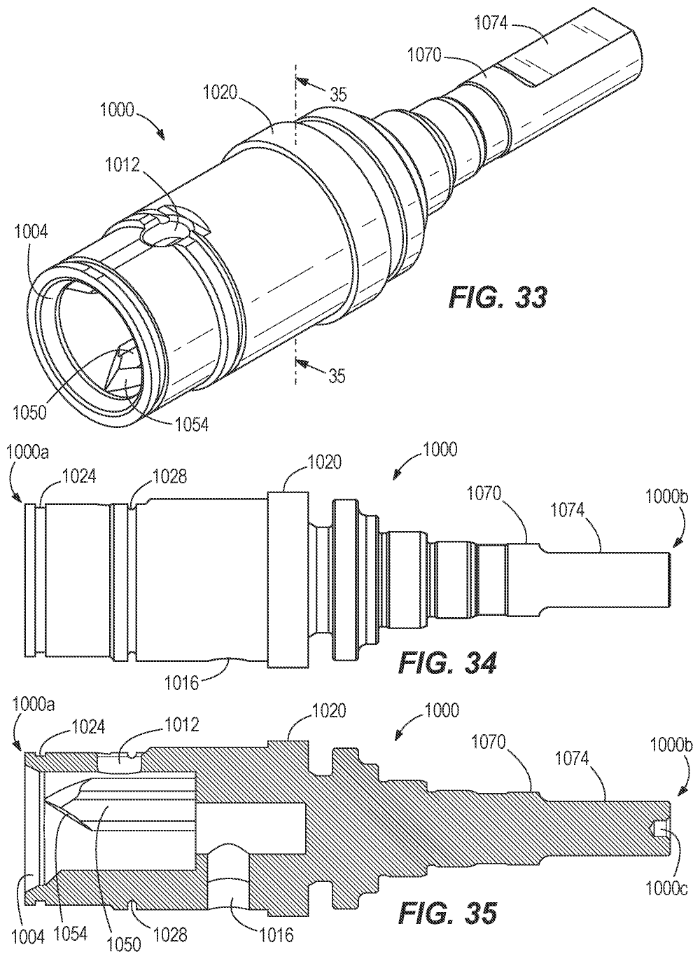

FIGS. 26-29 illustrate another portion of a tool bit 800. The tool bit 800 may be considered a large splined bit 800. The large splined bit 800 is configured to be received by an anvil 900 (FIGS. 30-32, discussed below) or a spindle 1000 (FIGS. 33-35, discussed below). The anvil 900 and spindle 1000 may also be configured to engage the tool bit 10 (FIGS. 1-4). The tool bit 800 (FIGS. 26-29) includes like features with the tool bit 500 which are annotated with like reference numerals in the “800” series of reference numbers. In the tool bit 800 (FIG. 29), the splines 812 include a maximum gap G3 (i.e., a spline width) between sidewalls thereof of approximately 0.635 centimeters (0.25 inches) (FIG. 29). In other embodiments, the gap G3 (i.e., the spline width) may be between 0.5 centimeters (about 0.2 inches) and 1 centimeter (about 0.4 inches). In other embodiments, the gap G3 (i.e., the spline width) may be between 0.6 centimeters (about 0.24 inches) and 0.7 centimeters (about 0.28 inches). However, the gap G3 may be larger or smaller depending on desired characteristics. As such, the spline 812 is generally considered a quarter inch spline. The maximum gap G3 is measured between the sidewall of each spline 812 at a radially outer surface of the spline 812. The splines 812 include a minimum gap G4 between sidewalls thereof of approximately 0.05 inches (FIG. 19). The minimum gap G4 is measured between the sidewalls of the spline 512 at a radially inner surface of the spline 812. As with the spline 512, the splines 812 may be either a negative feature (as illustrated in FIG. 26) extending radially inwardly towards the center of the tool bit 800 from a radially outer portion of the tool bit 800 or a positive feature (not shown) extending radially outwardly away from the center of the tool bit 800.

As illustrated in FIG. 27, the large splined bit 800 extends along an axial length dimension D10 between a first end 800a and a second end 800b thereof. The head 804 is adjacent the first end 800a thereof, and includes a diameter, or dimension D11. The shank 808 is adjacent the second end 800b thereof, and includes a diameter, or dimension D12 which is smaller than the diameter D11. In the illustrated embodiment, the dimension D10 is about 0.89 inches. In the illustrated embodiment, the dimension D11 is about 0.65 inches. In the illustrated embodiment, the dimension D12 is about 0.53 inches. As such, dimension D12 is approximately 82% of dimension D11 and approximately 66% of dimension D10 in the illustrated embodiment. Similarly, dimension D11 is approximately 73% of dimension D10 in the illustrated embodiment. In other embodiments, dimension D12 may be between 72% and 92% of dimension D11, and may be between 56% and 76% of dimension D10. In other embodiments, dimension D11 may be between 63% and 83% of dimension D10.

FIGS. 30-32 illustrate the anvil 900 configured for use with the tool bit 800. The anvil 900 is a base member 900 configured for use with the bit assembly 100. Like features between the anvil 300 and the anvil 900 are annotated with like reference numerals in the “900” series of reference numbers. The anvil 900 includes spline features 950 adjacent the opening 904 thereof. The spline features 950 are configured to transfer torque from the anvil 900 to the tool bit 800. The spline features 950 are provided adjacent the first end 900a of the anvil 900. The spline features 950 are provided with a tapered end 954 adjacent the first end 900a. During translation of the tool bit 800 into the anvil 900, and while the tool bit 800 is axially misaligned with the opening 904, the tapered end 954 may abut the chamfer 824 to guide the tool bit 800 into axial alignment with the anvil 900. The bit assembly 100 may be used to secure the tool bit 800 to the anvil 900. As with the spline features 650, the spline features 950 may be either a positive feature (as illustrated in FIG. 30) extending radially inwardly towards the center of the anvil 900 from a radially outer portion of the anvil 900 or a negative feature (not shown) extending radially outwardly from the center of the anvil 900 towards the radially outer portion of the anvil 900.

FIGS. 33-35 illustrate the spindle 1000 configured for use with the tool bit 500. The spindle is a base member 1000 configured for use with the bit assembly 100. Like features between the spindle 1000 and the spindle 700 are annotated with like reference numerals in the “1000” series of reference numbers. The spindle 1000 includes spindle features 750 adjacent the opening 704 thereof. The spline features 1050 are configured to transfer torque from the spindle 1000 to the tool bit 800. The spline features 1050 are provided adjacent the first end 1000a of the spindle 1000. The spline features 1050 are provided with a tapered end 754 adjacent the first end 1000a. During translation of the tool bit 500 into the spindle 1000, and while the tool bit 500 is axially misaligned with the opening 1004, the tapered end 1054 may abut the chamfer 824 to guide the tool bit 800 into axial alignment with the spindle 1000. The bit assembly 100 may be used to secure the tool bit 800 to the spindle 1000. The bit assembly 100 may be used to secure the tool bit 800 to the spindle 1000. As with the spline features 950, the spline features 1050 may be either a positive feature (as illustrated in FIG. 33) extending radially inwardly towards the center of the spindle 1000 from a radially outer portion of the spindle 1000 or a negative feature (not shown) extending radially outwardly from the center of the spindle 1000 towards the radially outer portion of the spindle 1000.

The tool bit 10 (FIGS. 1, 2, 4) may be secured via the bit assembly 100 to the anvil 600, the spindle 700, the anvil 900, or the spindle 1000. Dependent on the width between opposing sidewalls 50 of the splines 46 (FIG. 2), the splines 46 may generally correspond with the eighth inch splines 512 or the quarter inch splines 812 of the tool bits 500, 800, respectively. Attachment of the tool bit 10 via the bit assembly 100 may generally correspond with the attachment described above with reference to the tool bit 200 and the anvil 300.

Although the invention has been described in detail with reference to certain preferred embodiments, variations and modifications exist within the scope and spirit of one or more independent aspects of the invention as described.

Various features and advantages of the invention are set forth in the following claims.

1. A tool bit comprising:
a tip configured to engage a work surface;
a shank extending from the tip and defining a longitudinal axis; and
a drive portion coupled to an end of the shank opposite from the tip, the drive portion being configured to be engaged by a tool, the drive portion defining an outer dimension and a power groove recessed into the drive portion towards the longitudinal axis, the power groove defining a power groove dimension smaller than the outer dimension of the drive portion;
wherein the drive portion includes a plurality of splines circumferentially spaced around the longitudinal axis, each spline having opposing sidewalls which extend through the drive portion.

2. The tool bit of claim 1, wherein the shank has a reduced dimension measured perpendicular to the longitudinal axis compared to the remainder of the tool bit.

3. The tool bit of claim 1, wherein the plurality of splines is evenly circumferentially spaced around the longitudinal axis.

4. The tool bit of claim 1, wherein at least one sidewall of at least one of the plurality of splines is tapered with respect to the longitudinal axis.

5. The tool bit of claim 4, wherein the at least one sidewall converges in a direction extending from the drive portion towards the tip.

6. The tool bit of claim 1, wherein at least one sidewall is provided with a chamfered edge at a distal portion of the drive portion located opposite the tip.

7. The tool bit of claim 1, wherein the drive portion includes a shaft end alignment feature having a dimension extending perpendicular to the longitudinal axis that is larger than a remainder of the drive portion.

8. The tool bit of claim 1, wherein the drive portion includes a drive end alignment feature having a dimension extending perpendicular to the longitudinal axis that is smaller than a remainder of the drive portion.

9. (canceled)

10. The tool bit of claim 1, wherein the sidewalls are tapered at an angle relative to the axis with respect to a reference line extending in a direction perpendicular to the longitudinal axis and through both the longitudinal axis and the spline.

11. A bit holder assembly for securing a bit comprising a power groove to the bit holder assembly, the bit holder assembly comprising:
a base member including an opening;
an annular ring positioned outboard of the base member;
a barrel movable relative to the base member, the barrel including an inwardly extending surface;
a barrel spring positioned outboard of the base member between the annular ring and the inwardly extending surface;
a shuttle received within the opening and biased by a shuttle spring away from the base member, the shuttle including a cutout;
a first retainer located adjacent the bit; and
a second retainer located adjacent the shuttle,
wherein the bit holder assembly is movable between a released position in which the first retainer is removed from the power groove, and a locked position in which the first retainer is retained within the power groove and the second retainer is received in the cutout; and
wherein the barrel spring biases the barrel axially relative to the base member to inhibit the second retainer from moving.

12. The bit holder assembly of claim 11, wherein the opening has a hexagonally shaped cross section.

13. The bit holder assembly of claim 11, wherein the opening includes a spline feature that corresponds to a spline of the bit.

14. (canceled)

15. The bit holder assembly of claim 11, wherein in the released position the barrel acts against the bias of the barrel spring, and in the locked position the barrel is biased by the barrel spring.

16. The bit holder assembly of claim 11, wherein the first retainer if a first ball detent, and wherein the second retainer is a second ball detent.

17. The bit holder assembly of claim 11, wherein the base member includes a shoulder surface which may be secured to a drive for rotation.

18. The bit holder assembly of claim 11, wherein the shuttle includes an end having an angled surface and the bit further comprises a depression at an end of the bit, and wherein the angled surface is configured to be received within the depression when in the locked position.

19. The bit holder assembly of claim 18, wherein the opening of the base member is tapered such that as the bit is moved towards the locked position, the bit is axially and radially seated against the base member.

20. The bit holder assembly of claim 11, wherein the shuttle has a hole which at least partially receives the shuttle spring therein.

21. A bit holder for receiving a bit, the bit holder comprising:
a body having a first end and a second end opposite the first end, the second end configured to be secured to a drive for movement by the drive;
an opening formed through the first end of the body;
a spline feature positioned within the opening and between the first end and the second end;
wherein the spline feature includes a tapered end including a first surface and a second surface joined by an edge, whereby the first surface and the second surface face away from one another in a circumferential direction about the opening, and the tapered end faces the first end such that as the bit is moved into the opening and towards the second end, the spline feature abuts the bit to guide the bit into both circumferential alignment and axial alignment with the bit holder.

22. The bit holder of claim 21, wherein the spline feature is a positive feature which extends radially inwardly from a radial outer portion of the bit holder towards a center of the bit holder.

23. The bit holder of claim 21, wherein the spline feature is a negative feature which extends radially outwardly away from a center of the bit holder.

24. The bit holder of claim 21, wherein the spine features is one of a plurality of spline features spaced around the opening.
